(19) United States
(12) Patent Application Publication
(10) Pub. No.: US 2007/0115460 A1
(43) Pub. Date: May 24, 2007

(54) Method for examining molds and apparatus for accomplishing the same

(76) Inventors: Kevin Patrick Capaldo, Mt. Vernon, IN (US); Mark Allen Cheverton, Mechanicville, NY (US)

Correspondence Address: CANTOR COLBURN, LLP, 55 GRIFFIN ROAD SOUTH, BLOOMFIELD, CT, 06002, US

(21) Appl. No.: 11/285,329

(22) Filed: Nov. 21, 2005

(51) Int. Cl. G01N 21/00

(52) U.S. Cl. 356/237.1; 356/237.4; 356/237.2

(57) ABSTRACT

Disclosed herein is a defect detection apparatus comprising a first light source that emits light in a direction parallel to an apex of prismatic structures disposed on a mold; wherein an angle between a central axis of a beam of light emitted by the first light source and a vertical taken at the first light source is about 20 to about 90 degrees; a second light source that emits light in a direction perpendicular to the apex of the prismatic structures disposed on the mold; wherein an angle between a central axis of a beam of light emitted by the second light source and a vertical taken at the second light source is less than 45 degrees; a sample holder for holding the mold; a camera placed directly above the sample holder; and translational stages for supporting the camera and the sample holder.

### BACKGROUND

This disclosure relates to a method for examining molds and an apparatus for accomplishing the same. In particular, this disclosure relates to a method for examining molds for point defects and an apparatus for accomplishing the same.

In backlight computer displays or other display systems, optical films are often used to direct light. For example, in backlight displays, light management films use prismatic structures (often referred to as microstructure) to direct light along a viewing axis (i.e., an axis substantially normal to the display). Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs.

The prismatic structures are generally formed in a display film by replicating a metal tool or a mold having prismatic structures disposed thereon, via processes such as stamping, molding, embossing, or UV-curing. It is generally desirable for the display film and the mold to be free from defects so as to facilitate a uniform luminance of light. Since such structures serve to strongly enhance the brightness of a display, any defects, even if they are small (on the order of 10 microns), can result in either a very bright or very dark spot on the display, which is undesirable. The mold and the display films are therefore inspected to eliminate defects.

Detection of defects in molds is difficult however, since molds are manufactured from materials having specific optical properties that make defect detection difficult. It is therefore desirable to provide lighting for the mold that provides a contrast between a defect and the background so that defects may easily be detected.

### SUMMARY

Disclosed herein is a defect detection apparatus comprising a first light source that emits light in a direction parallel to an apex of prismatic structures disposed on a mold; wherein an angle between a central axis of a beam of light emitted by the first light source and a vertical taken at the first light source is about 20 to about 90 degrees; a second light source that emits light in a direction perpendicular to the apex of the prismatic structures disposed on the mold; wherein an angle between a central axis of a beam of light emitted by the second light source and a vertical taken at the second light source is less than 45 degrees; a sample holder for holding the mold; a camera disposed above the sample holder; and translational stages for supporting the camera and the sample holder.

Disclosed herein too is a method for detecting defects in a mold comprising illuminating a surface of the mold with a first light source; wherein the first light source emits light in a direction parallel to an apex of a prismatic structure disposed on the mold; wherein an angle between a central axis of a beam of light emitted by the first light source and a vertical taken at the first light source is about 20 to about 90 degrees; optionally illuminating the surface of the mold with a second light source; wherein the second light source emits light in a direction perpendicular to the light that is emitted by the first light source; and wherein an angle between a central axis of a beam of light emitted by the second light source and a vertical taken at the second light source is less than 45 degrees; and locating defects on the surface of the mold.

### DESCRIPTION OF FIGURES

FIG. 1 represents an exemplary top view of the mold inspection system 10;

FIG. 2 represents an exemplary side view of the mold inspection system 10;

FIG. 3 represents an exemplary end view of the mold inspection system 10;

FIG. 4 represents an exemplary view of the mold 24 having embossed prismatic structures disposed thereon; the figure also shows directions that are parallel and perpendicular to the apex of the prismatic structures;

FIG. 5 represents an expanded view of the circular section depicted in FIG. 4; and

FIG. 6 represents an exemplary view of a section of the mold 24 when the spotlights 4, 6 are used to illuminate defects located along the prism faces.

### DETAILED DESCRIPTION

Disclosed herein is an apparatus and a method for illuminating a mold such that defects present on the mold can be easily contrasted with the surrounding portions of the mold (hereinafter background) and therefore detected and identified. The molds are also known as shims. The apparatus advantageously combines using effective lighting positioning with effective camera location to illuminate and detect defects with minimal interference from the background. In one embodiment, the mold is illuminated with light that reflects off of the surface of the mold that has prismatic structures embossed thereon. The light is incident upon the surface of the mold in directions that are parallel as well as perpendicular to the apex of the prismatic structures.

The mold can be flat, curvilinear or in the form of a cylindrical drum. As noted above, the mold can be manufactured from a metal, a ceramic, or a plastic. The mold can also comprise composite materials, such as, for example, graphite composites. In one embodiment, the mold is a metal electroform that is used to manufacture prism sheets for use in backlight displays.

The apparatus comprises two light sources that illuminate the mold in mutually perpendicular directions. The light sources are arranged such that light incident on the mold in a direction that is parallel to the apex of the prismatic structures tends to enhance defects that are located along the prism tips. Light incident on the mold in a direction that is perpendicular to the faces of the prism or the apex of the prism tends to enhance defects that are on the prism faces. In this manner, the two lighting modes enhance all categories of defects that are detectable on the mold. In addition, this lighting technique increases the contrast between the background and the defects. In one embodiment, this illuminating of the mold in directions that are parallel and perpendicular to the apex of the prismatic structures makes the background dark and defects bright, thereby increasing the probability of defect detection.

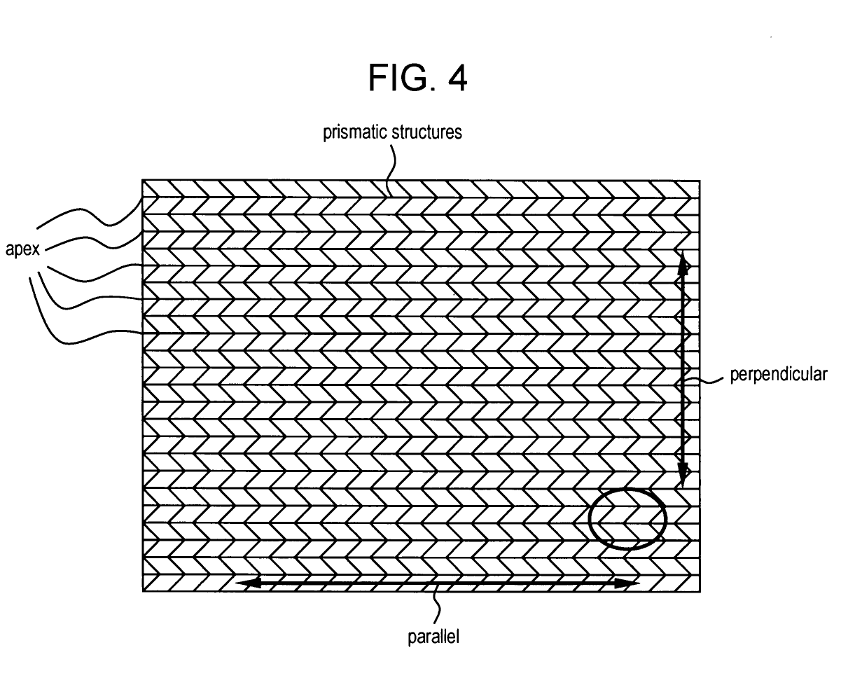

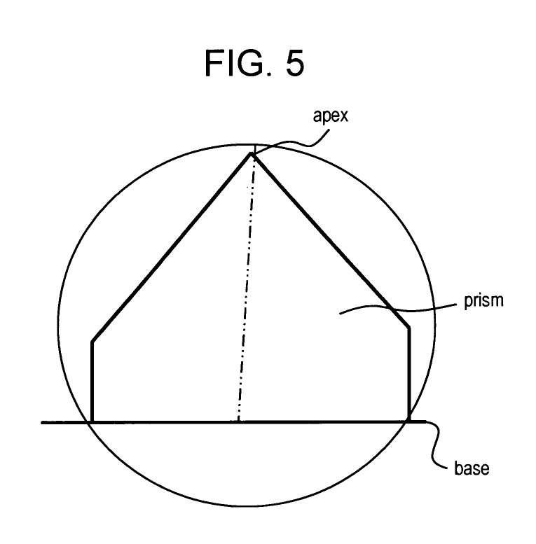

In one embodiment, the apparatus comprises a first light source (e.g., a line light, a spot light, an LED spot light, a diffuse spot light) that emits light in a direction parallel to an apex of the prismatic structures disposed on a mold; wherein the angle between the central axis of a beam of light emitted by the first light source and a vertical is less than 45 degrees; a second light source (e.g., a line light, a spot light, an LED spot light, a diffuse spot light) that emits light in a direction perpendicular to the apex of the prismatic structures disposed on a mold; wherein the angle between the central axis of a beam of light emitted by the second light source and a vertical is less than 45 degrees; a sample holder for holding the mold; and a camera placed directly above the sample holder for imaging defects. The apex of the prisms is depicted later in the FIGS. 4 and 5.

In another embodiment, a third light source (e.g., a line light, a spot light, an LED spot light, a diffuse spot light) can be disposed on an opposing side of the camera from the second light source such that both the second light source and the third light source illuminate the mold in opposing directions. Both the second light source and the third light source illuminate the mold in a direction that is perpendicular to the apex of the prismatic structures.

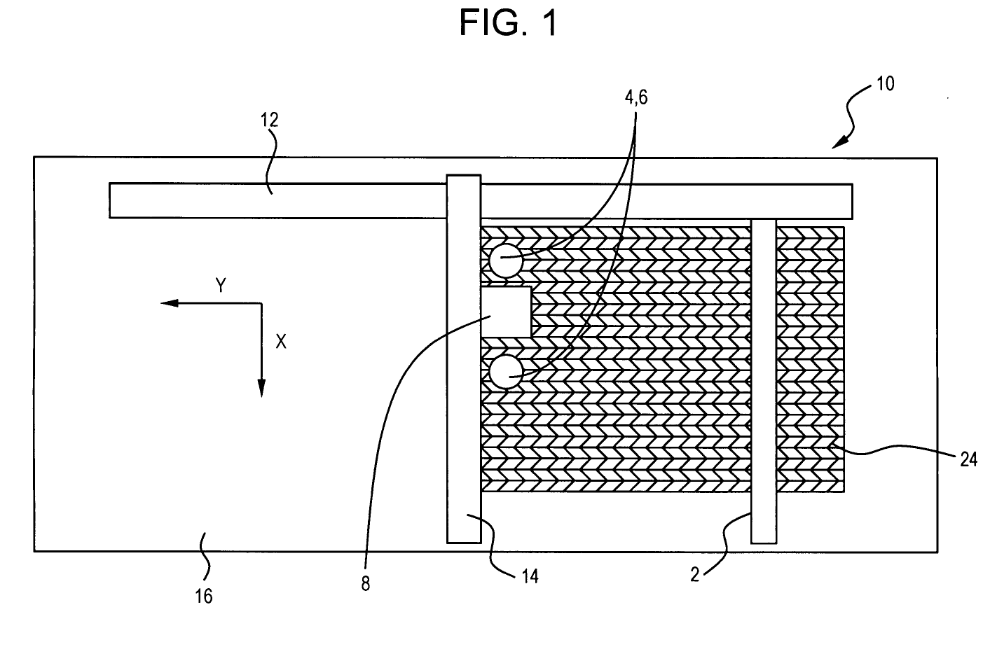

With reference now to the FIGS. 1, 2, and 3, an exemplary mold inspection system 10 comprises a first light source 2, a second light source 4, a third light source 6, and a camera 8 disposed on a translation stage 14. The line light 2 serves as the first light source. Spot lights are used as the second light source 4 and the third light source 6. The FIGS. 1, 2 and 3 represent an exemplary top view, side view and end view respectively of the mold inspection system 10. The line light 2 is positioned such that it emits light that is incident upon the mold at an angle and in a direction that it is parallel to the apex of the prismatic structures. A line light is a light source that has a dimension in one direction that is much greater than it dimensions in other directions.

There are typically two types of line lights, LED line lights and fiber optic line lights. In an LED line light, LEDs are positioned adjacent to each other such that a line of LEDs is formed. The length of the LED line light is determined by the total number of LEDs arranged in a single line and the width is determined by the width of each LED, which is generally very small when compared with the line length. If there are multiple lines of LEDs arranged parallel to each other, then the width of the LED line light is generally equal to the number of lines of LEDs. A fiber optic line light comprises a cylindrical fiber bundle that contains hundreds of individual optical fibers, each one less than a millimeter in diameter. This fiber bundle plugs into a light-emitting source. The fiber bundle transmits the light from the light-emitting source to the emitting end of the fiber bundle. The emitting end of the fiber line lights consist of the individual fibers positioned so that they form a line rather than a cylindrical bundle. The length of the fiber bundle is based on how many fibers are present while the width of the fiber line light is equal to the width of an individual fiber. The fiber line light and LED line light each comprises a cylindrical lens, so that the line of light that is formed can be varied in width. As noted above, while the FIGS. 1, 2 and 3 depict the first light source as a line light, other forms of lighting may also be used, such as, for example, a spot light, a diffuse spot light, LED spot lights, or the like.

Two spot lights 4, 6, positioned one on either side of the camera 8 emit light that is incident upon the mold (not shown) in a manner such that the light is incident upon the mold 24 at an angle and in a direction that it is perpendicular to the apex of the prismatic structures. The spot light 4 serves as the second light source, while the spot light 6 serves as the third light source. While FIGS. 1, 2 and 3 depict the second and third light sources 4, 6 as spot lights, other forms of lighting may also be used, such as, for example, line lights, diffuse spot lights, LED spot lights, or the like.

The camera 8 is in operative communication with a first translation stage 14 that can be displaced vertically or horizontally about a supporting column 18. The camera 8 can be an area camera or a line camera. The ability of the first translation stage 14 to be displaced vertically or horizontally about a supporting column 18 facilitates bringing the mold into the plane of focus of the camera 8. The motion of the first translation stage 14 can optionally be controlled by a control system, such as for example, a computer (not shown). A control device such as, for example, a stepper motor and a corresponding control system generally control the translational stage 14. An exemplary control device for the translational stage is a THK lead screw with stepper motors and encoders commercially available from THK.

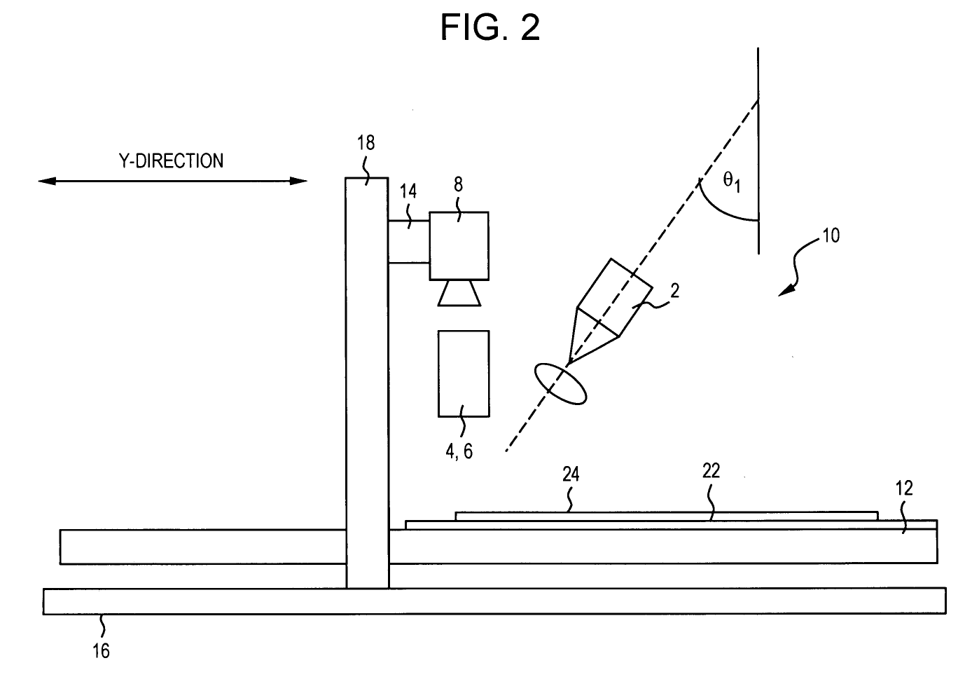

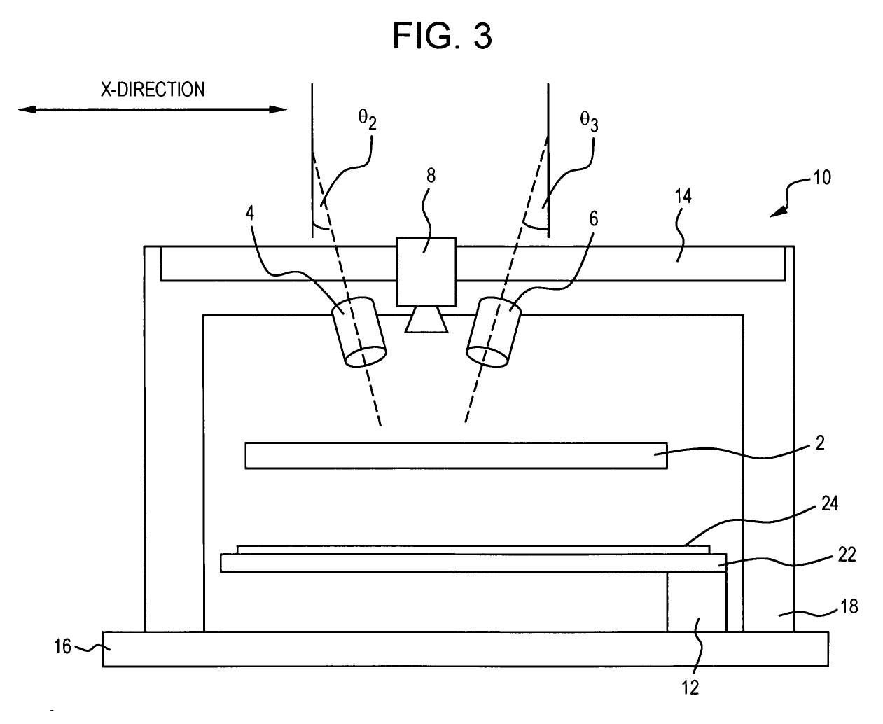

As can be seen from FIGS. 2 and 3, the supporting column 18 guides the first translation stage 14 during its vertical and/or horizontal motion. The supporting column 18 is fixedly attached to a table 16. A glass sample holder 22 (upon which the mold is mounted for inspection) is supported by a second translation stage 12 that is fixedly attached to the table 16. The glass sample holder 22 can also be moved horizontally or vertically along the second translation stage 12 in order to bring defects into better focus for the camera 8. A mold 24 is placed on the glass sample holder 22 for inspection. The spot lights 4, 6, the line light 2 and the camera 8 can all optionally be in electrical communication with a power source (not shown) and the control system (not shown). In addition, the spot lights 4, 6, and the line light 2 can be supported on the translational stages 12, 14 if desired or by other supporting structures (not shown).

FIG. 4 depicts a top view of the mold and shows the direction of the prismatic structures. FIG. 4 also depicts the direction of light that is incident upon the mold in a direction that is parallel as well as perpendicular to the apex of the prismatic structures. FIG. 5 is an expanded view of a section of the mold enclosed by a circle in the FIG. 4. As can be seen from FIG. 5, the circle encompasses a single prism embossed on the surface of the mold. The highest point of the section of the prismatic structure in FIG. 5 is termed the apex. The side opposed to the apex is termed the base of the prismatic structure. Thus referring back to FIG. 4, each prism has an apex that is represented by a line that forms the peak of the prismatic structures. The light from the line light source is parallel to the apex (peak) of the prismatic structures while the light from the spot lights is perpendicular to the apex of the prismatic structures.

The prismatic structures present on the mold 24 can have defects at the tips, valleys or along the faces of the prisms. These defects are generally classified into two types of defects namely integral and removable defects. Integral defects are defects that are caused because of defects that inherent in the mold. Such integral defects are caused by physical damage that is present on the mold. These defects are generally called scratches, dashes or separation marks.

Removable defects are superficial defects, which are often called stains, dust, spiders, white spots, blue spots or whiskers. These defects are caused by the presence of removable debris on the mold. If these defects are tended to before the parent mold is reproduced into daughter molds it will improve the overall yield. A parent mold is the first template made from a given form while the daughter mold are reproductions of the parent mold that are generally manufactured using the parent mold as a template. Successive generations of daughter molds can be manufactured from each generation of daughter molds. If both removable and/or integral defects are missed during inspections of the mold they will translate into defects in the structured display film. Such defects will be repeated during the manufacturing process as display films are mass-produced using the defective molds and will reduce the overall yield for producing advanced display films.

With reference now once again to the FIGS. 2 and 3, it may be seen that the light sources are inclined with respect to the vertical. For example in FIG. 2, the central axis of the beam of light emitted by the line light 2 is inclined at an angle θ₁ with respect to the vertical. The light emitted by the line light 2 is in a direction that is parallel to an apex of the prismatic structures on the mold. As noted above, the line light source is a fiber light source. An exemplary fiber light source is a Schott MHR50 metal halide light source having a 50 Watt (W) metal halide bulb. The line light 2 is about 12 inches in length. An exemplary fiber line light is a SchottA08912, commercially available from Schott. The line light is generally located at a distance of about 7 to about 10 inches (about 15 to about 26 centimeters) from the surface of the mold during a defect detection process.

In one embodiment, the angle θ₁ can be varied in an amount of about 20 degrees to about 90 degrees with respect to the vertical while emitting light in a direction that is parallel to the apex of the prismatic structures on the mold. In another embodiment, the angle θ₁ can be varied in an amount of about 22 degrees to about 60 degrees with respect to the vertical. In yet another embodiment, the angle θ₁ can be varied in an amount of about 24 degrees to about 55 degrees with respect to the vertical. In an exemplary embodiment, the angle θ₁ is about 26 degrees to about 45 degrees with respect to the vertical.

In one embodiment, the line light 2 is maintained as bright as possible. The use of the line light 2 to illuminate the mold 24 in a direction parallel to apex of the prismatic structures enhances the visibility and detection capabilities of defects present at the prism tips. In one embodiment, the line light 2 has a light intensity of greater than or equal to about 5,000 W/m² at the surface of the mold 24. In one embodiment, the line light 2 has a light intensity of greater than or equal to about 10,000 W/m² at the surface of the mold 24. In one embodiment, the line light 2 has a light intensity of greater than or equal to about 15,000 W/m² at the surface of the mold 24. In one embodiment, the line light 2 has a light intensity of greater than or equal to about 25,000 W/m² at the surface of the mold 24. An exemplary light intensity at the surface of the mold 24 is about 25,800 W/m².

FIG. 3 also shows that the spot lights 4, 6, are inclined at angles θ₂ and θ₃ with respect to the vertical. The spot lights 4, 6, are disposed on opposing sides of the camera 8 and illuminate the mold in opposing directions. The light emitted from spot light 4 travels in the direction of spot light 6 and the light emitted from spot light 6 travels in the direction of spot light 4. The light is emitted in a direction that is perpendicular to the apex of the prismatic structures on the mold. In one embodiment, the angles θ₂ and θ₃ can each be varied in an amount of about 10 degrees to about 45 degrees with respect to the vertical while emitting light in a direction that is perpendicular to the apex of the prismatic structures on the mold. In another embodiment, the angles θ₂ and θ₃ can each be varied in an amount of about 20 degrees to about 40 degrees with respect to the vertical. In yet another embodiment, the angles θ₂ and θ₃ can each be varied in an amount of about 25 degrees to about 38 degrees with respect to the vertical. In an exemplary embodiment, the angles θ₂ and θ₃ can each be varied in an amount of about 27 degrees to about 35 degrees with respect to the vertical.

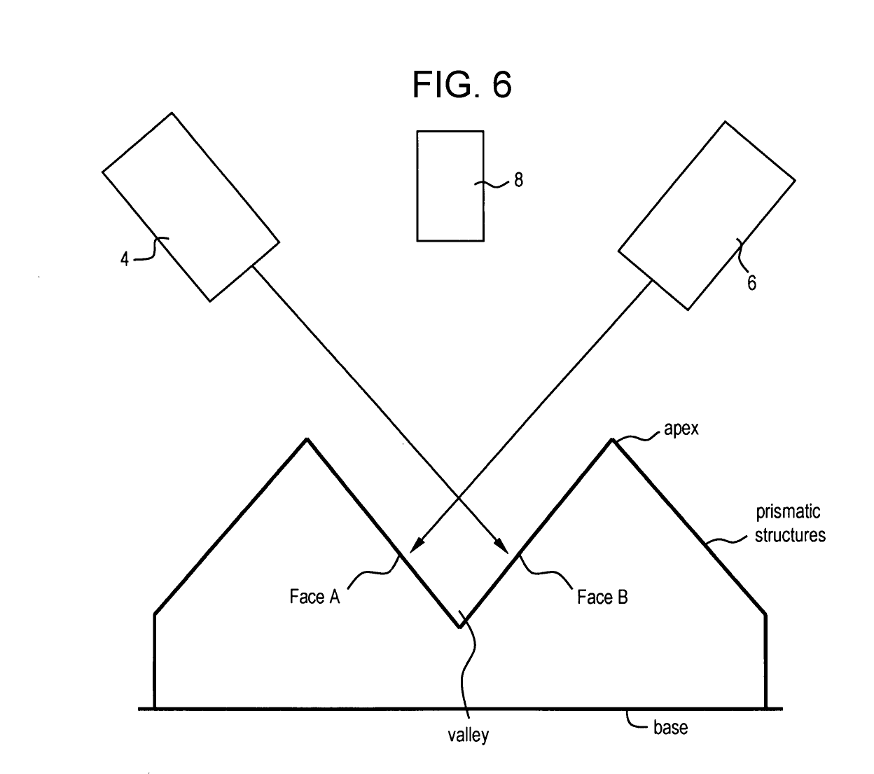

As noted above, the spot lights 4, 6, are positioned on either side of the camera 8 so that they emit a light that is perpendicular to the apex of the prismatic structures on the mold 24. As can be seen in the FIG. 6, the use of the spot lights 4, 6, to illuminate the mold 24 in a direction perpendicular to the apex of the prismatic structures enhances the visibility and detection capabilities of defects present on the prism faces. As can be seen in the FIG. 6, the spot lights 4, 6 are located to illuminate defects present on the prism faces and in the prism valleys. In particular, the spot lights 4, 6 are positioned to illuminate the opposing faces (e.g., Face A and Face B in the FIG. 6) of the prismatic structures so that defects can be easily detected. In one embodiment, the spot lights 4, 6 are light emission diodes (LED). Exemplary spot lights are available from CCS America LSP-41. Up to about 20 LEDs providing red diffuse light can be used in each spot light. In another embodiment, white lights may be used instead of red lights.

In operating the spot lights 4, 6, to detect defects on the mold, the intensity of the spot lights 4, 6, is reduced when compared with the intensity of the line light 2. In one embodiment, the spot light 4 has a light intensity of less than or equal to about 26 W/m² at the surface of the mold 24. In another embodiment, the spot light 4 has a light intensity of less than or equal to about 20 W/m² at the surface of the mold 24. In yet another embodiment, the spot light 6, has a light intensity of less than or equal to about 16 W/m² at the surface of the mold 24. In yet another embodiment, the spot light 6, has a light intensity of less than or equal to about 12 W/m² at the surface of the mold 24.

The camera 8 is disposed perpendicular to the mold 24 and directly above it. Images of the mold 24 along with the defects are captured by the camera 8 and transferred to the control system. An exemplary control system is a computer. The coordinates and texture of the respective defects are determined by the computer and stored in a memory device for further analysis.

In one embodiment, the camera 8 is a digital camera. The camera 8 may optionally be provided with polarizing lenses for enhanced detection of certain defects. An exemplary camera is a Basler 4K pixel line scan, model L201 commercially available from Basler Vision Technologies.

As noted above, by illuminating the mold in a direction parallel to the apex of the prismatic structures, defects along the prism tips are illuminated. By illuminating the mold in a direction perpendicular to the apex of the prismatic structures, defects on the prism face are illuminated. Thus, by using the lighting sequentially, separate classes of defects can be detected and imaged. On the other hand, by illuminating the mold with both sets of lights simultaneously, all classes of defects can be detected and imaged. By using both sets of lights simultaneously, the surface of the mold (i.e., the background) appears very dark and the defects appear very bright, thereby increasing the probability of defect detection.

This method of defect detection system can either be conducted in a batch fashion where one mold after another is manually mounted on the sample holder and examined. Alternatively, the system can be automated and can continuously examine molds that are brought into the view of the camera by means of a conveyer belt. In one embodiment, the conveyer belt having molds disposed thereon for inspection purposes can travel at a speed of greater than or equal to about 25 feet per minute. In another embodiment, the conveyer belt can travel at a speed of greater than or equal to about 50 feet per minute. In yet another embodiment, the conveyer belt can travel at a speed of greater than or equal to about 100 feet per minute. In order to accommodate greater conveyor speeds, the camera shutter speed can be increased accordingly to detect defects.

As noted above, the mold inspection system 10 can be advantageously used to detect defects located on the edges or on the faces of the prismatic structures either sequentially or simultaneously. These defects can be imaged and stored on a memory device such as a computer hard drive for analysis. The system can be operated in batch mode or in continuous mode for detecting defects.

As noted above, this method can be used to detect defects on cylindrical or curvilinear surfaces. In an exemplary embodiment, a cylindrical mold can be mounted on a shaft and illuminated with the first, second and third light sources as detailed above. The shaft can be rotated manually or by using an electromotive force. In another exemplary embodiment, a stepper motor can be used to rotate the cylindrical mold. The camera can be use to image the cylindrical mold and to determine the location of defects.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A defect detection apparatus comprising:
a first light source that emits light in a direction parallel to an apex of prismatic structures disposed on a mold; wherein an angle between a central axis of a beam of light emitted by the first light source and a vertical taken at the first light source is about 20 to about 90 degrees;
a second light source that emits light in a direction perpendicular to the apex of the prismatic structures disposed on the mold; wherein an angle between a central axis of a beam of light emitted by the second light source and a vertical taken at the second light source is less than 45 degrees;
a sample holder for holding the mold;
a camera disposed above the sample holder; and
translational stages for supporting the camera and the sample holder.

2. The method of claim 1, further comprising a third light source that emits light in a direction perpendicular to the apex of the prismatic structures disposed on the mold; wherein an angle between a central axis of a beam of light emitted by the third light source and a vertical taken at the third light source is less than 45 degrees.

3. The method of claim 2, wherein the third light source is disposed on an opposing side of the camera from the second light source.

4. The method of claim 3, wherein the second light source and the third light source comprise light emitting diodes.

5. The method of claim 4, wherein the second light source and the third light source produce a light intensity of less than or equal to about 26 watts per square meter at the surface of the mold.

6. The method of claim 4, wherein the first light source comprises a line light.

7. The method of claim 2, wherein the second light source and the third light source are spot lights.

8. The method of claim 1, wherein the translational stage is in operative communication with a stepper motor.

9. The method of claim 1, wherein the camera, first light source and the second light source are in electrical communication with a power source and a computer.

10. The method of claim 1, wherein the sample holder is mounted on a conveyor belt.

11. A method for detecting defects in a mold comprising:
illuminating a surface of the mold with a first light source; wherein the first light source emits light in a direction parallel to an apex of a prismatic structure disposed on the mold; wherein an angle between a central axis of a beam of light emitted by the first light source and a vertical taken at the first light source is about 20 to about 90 degrees;
optionally illuminating the surface of the mold with a second light source; wherein the second light source emits light in a direction perpendicular to the light that is emitted by the first light source; and wherein an angle between a central axis of a beam of light emitted by the second light source and a vertical taken at the second light source is less than 45 degrees; and
locating defects on the surface of the mold.

12. The method of claim 11, further comprising illuminating the surface of the mold with a third light source that emits light in a direction perpendicular to the light that is emitted by the first light source; and wherein an angle between a central axis of a beam of light emitted by the third light source and a vertical taken at the third light source is less than 45 degrees.

13. The method of claim 11, wherein the first light source, the second light source and a third light source are used simultaneously.

14. The method of claim 11, wherein the first light source is used prior to using the second light source and a third light source.

15. The method of claim 11, wherein the second light source and a third light source are used prior to the first light source.

16. The method of claim 11, further comprising capturing an image of the mold on a camera.

17. The method of claim 11, further comprising displacing a translation stage upon which the mold is mounted.

18. The method of claim 11, further comprising displacing a translation stage upon which the camera is mounted.

19. The method of claim 11, wherein the mold is flat, cylindrical or curvilinear.

20. The method of claim 11, wherein the mold is a metal electroform.

21. An apparatus that employs the method of claim 11.
